(19) United States
(12) Patent Application Publication
(10) Pub. No.: US 2011/0072313 A1
(43) Pub. Date: Mar. 24, 2011

(54) SYSTEM FOR PROVIDING FAULT TOLERANCE FOR AT LEAST ONE MICRO CONTROLLER UNIT

(75) Inventors: Peter Fuhrmann, Aachen (DE); Markus Baumeister, Munich (DE); Manfred Zinke, Aachen (DE)

(73) Assignee: NXP B.V., Eindhoven (NL)

(21) Appl. No.: 12/673,874

(22) PCT Filed: Aug. 7, 2008
(86) PCT No.: PCT/IB2008/053178

§ 371 Date: Feb. 17, 2010

(30) Foreign Application Priority Data
Aug. 17, 2007 (EP) 07114495.0

(51) Int. Cl. G06F 11/00; G06F 11/30

(52) U.S. Cl. 714/47.1; 714/E11.179

(57) ABSTRACT

The invention relates to a system for providing fault tolerance for at least one micro controller unit, hereinafter called MCU (10). The MCU receives information from at least one sensor (11) coupled to the MCU (10) and outputs information to at least one actuator (12) coupled to the MCU (10). To provide a system for controlling or influencing the fault tolerance or the error processing of at least one MCU without requiring a replication of software or hardware components and which is able to react differently on various events it is proposed to include a System Supervision unit (200), hereinafter called SSU (200), in the MCU (10). The SSU (200) reacts on error reports included in information (301, 302, 303, 325) received at the SSU (200); wherein the SSU (200) is adapted to switch into one of a plurality of predetermined states based on the information (301, 302, 303) received and based on a state history of the MCU (10); and to output at least one instruction to the MCU (10) or to an external control device (230) coupled to the MCU (10) to control at least the MCU (10) and/or the connected devices (11, 12) based on the new state into which the SSU is switched. Such system could be easily adapted to the respective application.

### FIELD OF THE INVENTION

The invention relates to a system for providing fault tolerance for at least one micro controller unit, hereinafter called MCU.

### BACKGROUND OF THE INVENTION

The ongoing development of cars with respect to driving safety and increased requirements with respect to entertainment and infotainment results in a drastical increase of electronic modules in the car. Most of the electronic modules are integrated on a chip, wherein each electronic module includes a plurality of different functions, each integrated on one chip. Such electronic modules including different functions on one chip are micro controller units, called MCU. Moreover, to share information of the multiple MCUs e.g. in one car there is a need for a communication network for exchanging information sensed or processed by the single MCUs. On the other hand a plurality of safety-relevant applications in the automotive area, like airbags, ABS or the like require a reliable operation also in case of hardware or software errors.

In general, safety-relevant applications in digital systems must ensure various levels of error detection and error processing based on the involved risk. Requirements for such applications are specified by the IEC 61508 standard. This standard defines upper limits for the fraction of undetected dangerous failures among all failures as well as upper limits for the probability of such failures. Those limits depend on the required risk reduction level and are rather low for application classes like safety-related applications in cars (≦1% resp. 10⁻⁷/hour).

Several categories of solutions are employed to reach those limits, for example dual lock-step architectures, error masking by replication, consistency checks performed by independent hardware or software time-diversity. All of these solutions have the problem that they require either the replication of software or hardware components or a mixture of both and thus increase cost.

Therefore there is a need to achieve a high rate of failure detection without replication. Such a solution can be achieved by integrating consistency checks within the individual sub-units of an MCU. The close integration into the existing hardware allows the overhead to be low and errors to be detected early.

EP 1496435 describes a solution for detecting errors. However, there is still a way missing which aggregates the error reports from such integrated consistency checkers and reacts to them according to the needs of a specific safety function.

### OBJECT AND SUMMARY OF THE INVENTION

Therefore it is object of the present invention to provide a system for controlling or influencing the fault tolerance or the error processing of at least one MCU without requiring a replication of software or hardware components and which is able to react differently on various events. Moreover, the system should be able to be easily adapted to the respective application.

The object is solved by the features of the independent claim 1.

Further advantages could be recognized from the dependent claims.

The invention is based on the thought that a consistent reaction on detected errors is required, wherein the reaction desired can depend on the error itself, the state the whole system or the MCU is in, on previous errors, or on time constraints. Specifically the preferred reaction to the error might be so complex that it can only be implemented in software but the software and its executing CPU might themselves be erroneous. Thus there is a variability of error reactions together with the need to guarantee the handling of error reports.

To comply with such situation it is proposed to consider not only the information of a certain component of a MCU. Furthermore, it is required to provide the ability to react differently on different errors. Therefore it is proposed to include a system supervision unit, called SSU, into the MCU. Before reacting to a certain event or error code received from the MCU, the SSU considers the history or at least the former internal state of the MCU. The SSU could be switched only in predefined states, wherein the transition from one internal state to another internal state is well defined. Thereby it is avoided to switch the SSU or the whole MCU into undefined states. Moreover, it is possible to consider the information received from the MCU and to consider at least the former state of the MCU and to define exactly how to react in a certain internal state. If the SSU is changing its internal state due to an event or information received from the MCU it will execute actions associated to the new internal state of the SSU. Such actions can comprise changing the state of signalling lines, changing the content of registers, or sending data over the system bus. All of these action representations can in turn cause the SSU or other components internal or external to the MCU to execute actions on their own. Thus the SSU actions can be seen as commands sent to the SSU or other components of the system.

The SSU is realized as a hardware component together with the MCU on a single chip.

The SSU will receive reports from hardware units included into the MCU checking the consistency of operation of the MCU including its CPU. These units will be called “monitor” in the following. The SSU itself is also a component of the MCU and preferably realized with self-checking, fault-tolerant technology such as Triple Modular Redundancy (TMR) so no specific monitor is needed to check the SSU itself.

Furthermore, the SSU can interact with software running on the CPU with mechanisms as described below. The SSU will possibly forward error reports coming from the monitors to the software allowing the software to react on the report or influence the SSU's reaction.

This concept provides the following advantages:

Since the states are known to the SSU, the transitions between the defined states and the actions executed by the SSU are programmable. Thus, the system for providing fault tolerance can be modified in its reactions by the user of the MCU (i.e. system designer). This is advantageous as reactions could depend on application, specific usage of the system and architecture of the system.

The abstraction of the error reactions of the SSU into a system of states, transitions and actions keeps the SSU implementation simple and thus makes a self-checking implementation of the SSU possible.

The interaction with the software allows to include the software running on the normal CPU of the MCU and its states into the decision loop on the error reaction. This is advantageous as some information required for the decision may only be available to the software, for example the software might decide that the system is still able to continue in a safe state after a connection to a sensor failed as a fallback sensor provided consistent information over the last minutes and thus no error reaction is necessary.

Further, the system provides the ability to include the software into the actual reaction on the error. This is advantages as some functionality for the reaction may only be available to software, for example after a failure several ways may exist to bring the system back into a safe state, a simple one (e.g. switch off power) which can be initiated by the SSU alone and a more user-friendly one (bring specific actuators into a defined state and continue to work in a degraded way with the rest) which is too complex to be executed without involvement of the software.

The mechanisms in the SSU will aggregate error reports from various monitors into the decision on moving into a new state. Since only this one transition into the new state is communicated to the safety integrity software (and not the individual error reports), the software is informed of the current consistency level of the MCU without being overloaded with lots of error reports in a short time.

Due to the software interaction mechanism described below the SSU is able to continue to work and to bring the system into a safe state even when the software itself or the processing subsystem used by the software fails.

More Detailed Description:

The SSU is responsible to determine the reaction of the MCU to a detected internal error. For providing such function the SSU executes the following actions:
It receives error information from any MCU subcomponent, from monitors, or from SSU internal timers, counters or registers.
Further, the SSU checks an internal state (e.g. whether similar errors were reported lately).
Moreover, it decides an action based on an error and a state using a programmable collection of error reactions. If the error is critical and the system safety time (sst) short, the SSU will decide on the reaction alone and execute it. Possible error reaction of the SSU are, for example, to trigger a safety switch for switching off the connected devices, to initiate various resets of all or of parts of the MCU or to bring the MCU into and keep it in a FAILURE mode. If possible failures are uncritical or are expected to be resolved within a system safety time, the SSU may inform the safety software running on the CPU of the MCU using the invented mechanism described below.
However, if the software does not provide a reaction within a set time, the SSU may continue with an appropriate error reaction to guarantee a predetermined reaction and to bring the MCU into a safe state
In case that the software requests more time or indicates that the error is under control, the SSU may respect this request if the error reaction definition allows for it.

According to a preferred embodiment of the invention, the SSU includes a finite state automaton, called FSA. The FSA includes an information input port, a state switching unit and execution unit and an information output port. The FSA receives a plurality of information from the MCU or from the connected components of the SSU. Based on the received information and based on a state history of the MCU, which is stored in the FSA, the state switching unit is adapted to switch into one of a plurality of predetermined internal states. According to the newly switched internal state or according to the state transition passed by the state switching unit, the execution unit will execute at least one action. Based on the current internal state and based on the execution of the actions by the execution unit, the FSA may output at least one instruction to the MCU or to the external control devices via the information output port. The advantage of using an FSA is that a FSA progresses from state to state when an error report arrives, wherein the output of the FSA triggers the execution of short simple programs on the SSU to influence internal registers or counters of the MCU. The definition of most state transitions is freely definable by the system designer and may be preconfigured or loaded into the SSU at system start-up. Some state transitions might also be non-modifiable and preconfigured by the MCU manufacturer, e.g. reactions on errors during the early stages of the MCU boot process.

Thus, the FSA can only switch from one defined state to another defined state in case of predetermined events and former internal states. This provides the advantage that in contrast to a simple error-reaction-mapping-based approach, the SSU can react differently to the same error under different conditions (e.g. different former internal states). Moreover, in contrast to a non-programmable approach, the system designer can define hardware executed error reactions according to the system's need.

The execution unit is able to set a signal line. Thus, based on the current internal state of the FSA, the output of the FSA may switch a signal line from an off-state to an on-state. Moreover, the output port is able to instruct or to program SSU internal registers to a predetermined value.

The MCU is a central component of a so-called communication node within an automotive network (IVN). Each communication node may be coupled to a sensor or may include a sensor for sensing different states of the vehicle or of the environment or a MCU may be coupled to an actuator which is performing a predetermined function based on received signals from a processing unit or from another MCU.

According to the preferred embodiment, the SSU may be connected to an external control device which is able to control the whole system in respect to its safe state (often by controlling the power supply). The whole system may include a plurality of MCUs each coupled to connected devices like sensors or actuators. In particular, the external control device is realized as a safety switch, which may transfer the controlled system into a safe state after a respective output signal at the output port of the FSA. In such a case, the safety switch receives a predetermined instruction from the SSU. The safety switch may preferably transfer all connected devices into a safe state or alternatively only parts of them and all or parts of the MCU.

Each MCU includes a CPU. A plurality of software programs at least an operation system and application specific software are running on the CPU. The application specific software can in principle be divided into three kinds: First, non safety-relevant software, i.e. software which is not involved in the proper functioning of the safety-critical system. This kind of software is ignored in the following. Second, safety software, i.e. the software responsible to control the safety-critical components of the system for normal application. Third, safety integrity software, i.e. software which is responsible to ensure that the overall system as well as the safety software is in a safe state and take counter measures, such as switching off the system, if this is no longer the case. The SSU communicates with the safety integrity software to provide error conditions to the software or to receive error reports from it. The safety integrity software may in turn communicate with the safety software to switch it to other modes or to retrieve additional information from it. Since all software executes on the CPU and typically requires memory and a bus (together often called processing subsystem), any error of the processing endangers the integrity of the software which therefore cannot be trusted to always work correctly.

Thus, to accomplish this interaction with the safety integrity software in a safe way, the SSU comprises a software interaction register, which mediates between the FSA and the software. The software interaction register allows the SSU to detect if an interaction with safety integrity functions realized in software is not working properly. For this the software interaction register receives an expected error code answer from the FSA when the FSA (on behalf of the SSU) notifies the software of an error. The software interaction register further receives an error code answer from the software when the software is able to take care of the reported error. In a preferred embodiment this error code answer of the software is calculated by the software in several steps distributed over the error processing functions to ensure that all were executed. The software interaction register compares the expected answer and the received answer and notifies the FSA when these don't match or when no answer from the software was received within a predetermined time.

Thus, it is possible to include the safety integrity functions of the software into the decision loop and to provide the possibility to solve certain errors within the software without direct influence of the MCU by the SSU. In case that the detected error could not be solved by the software, the software interaction register will not receive an answer from the software which corresponds to the expected error code answer. This result will be transferred to the FSA, which is then executing a predetermined action and is outputting predetermined instructions to the respective parts of the MCU to guarantee a safe state of the controlled system.

Moreover, the software interaction register will send a “time is up” information to the FSA, if an error code answer from the software is not received in time. This could be caused for example by an undetected error in the CPU executing the software or by a systematic error within the software (e.g. “endless loop”). The FSA may react differently when the software provides a wrong error code answer to the software interaction register compared with a situation when the FSA receives the “time is up” information from the software interaction register but in both cases the SSU will bring the system into a safe state on its own.

Further, in a preferred embodiment of the invention, the system includes at least one monitoring unit, which is adapted to detect errors in various components of the MCU and to report these errors to the SSU, where these are interpreted by the FSA. For providing such error reports, the monitoring unit is monitoring inputs and outputs of the MCU component and will detect an inconsistent behavior of the monitored component by checking the relationship of the input and output values against the known expected behavior of the component and possibly comparing them with additional information stored within the monitoring unit. Such monitoring units could be realized e.g. as described in EP 1496435.

The monitoring units serve as entities functionally independent of the supervised entities (such as the CPU, the memory, the bus, the peripherals, . . . ) and are thus less likely to be subject to common cause failures together with their supervised components. Thus, there are three measures in pike for the SSU to detect a failure of the processing subsystem (CPU, bus, memory) running the safety integrity software: A monitoring unit reports an error, the error code answer written into the software interaction register does not correspond with the expected answer or there is no error code answer in time.

In a further preferred embodiment of the invention, the safety integrity software may transmit a software request signal to the SSU for requesting the SSU to change its internal state for diagnosis of, for example, the safety switch.

Also the safety integrity software running on the CPU might detect an error external to the MCU using e.g. consistency test between different sensors and might thus want to bring the system into the safe state by activating the safety switch. It is preferred that this is realized by the software transmitting a state change request to the SSU so that the SSU continuously has an overview over the MCU and system state and is informed about, e.g. any remaining redundancy reserves.

Moreover, the system may include a counter, which is set by the outputs of the FSA and which is able to start at least one count and decrement or increment the started counts or to reset the counts based on the outputs of the FSA and to send an event signal to the FSA if the count reaches any predetermined value. By this, the FSA is given the ability to count without exploding the number of states required as would happen if counting was realized within the FSA state space.

Such counter may be used for counting, e.g. how much redundancy remains or how often a predetermined error occurs. In case that a certain count reaches a limit, the counter informs the FSA via an event and thus the FSA may react based on the number of occurrence of a predetermined error.

Moreover, the system includes a timer which may be started or stopped based on internal states of the SSA, wherein in case of reaching a predetermined threshold a “time is up” signal is outputted to the FSA to indicate that a predetermined time interval is expired. This gives the FSA the ability to measure a time interval (to e.g. provide time for cleanup attempts of the software before forced system shutdown or to regularly reset error counters) an ability normally not available to FSAs.

The FSA may include a storage unit for storing a state-transition table in which the transitions between internal states are defined to which the FSA is switched in case of a predetermined information or event. Moreover, the storage unit could store an action list per internal state or state transition, which is executed in case the state is reached or the transition is passed.

### BRIEF DESCRIPTION OF THE DRAWINGS

In the following preferred embodiments will be explained based on the accompanying drawings.

FIG. 1a shows a simple system according to the invention;

FIG. 1b shows a more complex system according to the present invention;

FIG. 2 shows a block diagram of an MCU according to the invention;

FIG. 3 illustrates the internal structure of the SSU according to the present invention;

FIG. 4 shows the internal structure of the FSA according to the present invention; and

FIG. 5 shows the internal structure of the software interaction register according to the present invention.

### DESCRIPTION OF EMBODIMENTS

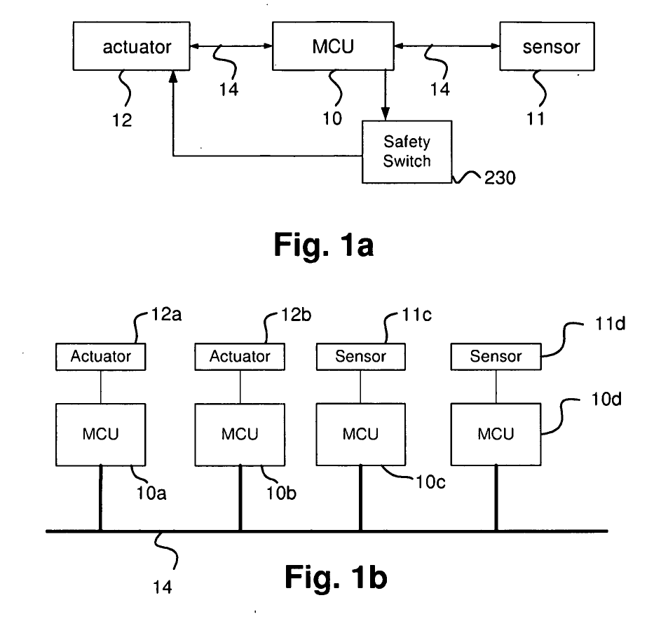

In FIG. 1, the system according to the present invention includes only one MCU 10, which is coupled via communication line 14 with a sensor 11 and an actuator 12. Moreover, a safety switch 230 is connected to the MCU 10 for controlling the connected devices 11, 12.

A more complicated system, which may be applied in a vehicle is shown in FIG. 1b. There are a plurality of MCUs 10a-10d, which are each coupled to a sensor 11c, 11d or an actuator 12a, 12b. The MCUs are coupled to the communication line 14, which may be an in-vehicle network (IVN). Obviously, even more complicated setups are possible involving more MCUs and several sensors, actuators or networks per MCU.

The sensor 11d may be an impact sensor, which is required for determining whether the explosive package of an airbag (squib) 12a should be started or not. The sensor 11c may be a sensor for measuring a distance to an object, which may be also used for determining whether a break assistant should interfere in the driver control. The actuators 12a, 12b may be for instance an at least one squib or the break assistant or one pressure regulator of the ABS system.

Information provided by the sensors 11c, 11d is processed within the MCUs 10c, 10d and transferred to the respective MCUs 10a or 10b to control the respective actuators 12a, 12b dependent on the application. Also this embodiment may be equipped with a safety switch (not illustrated) for all connected devices 11c, 11d, 12a, 12b.

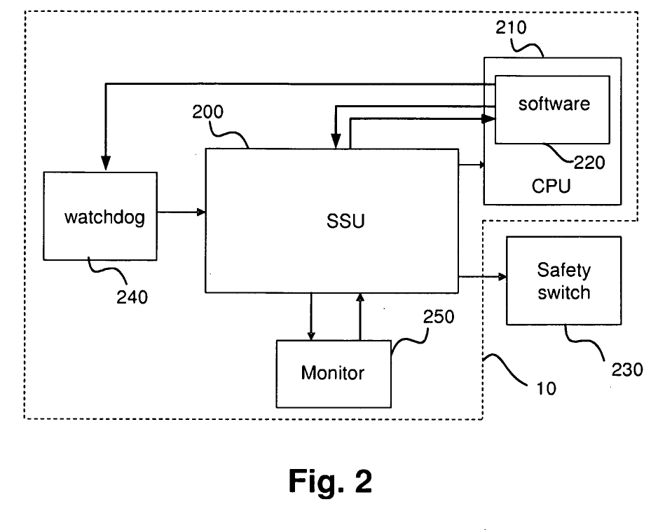

In FIG. 2, a very abstract view of the interactions within an MCU is shown. The MCU is a system on chip (SOC), which includes a CPU 210 on which at least a safety software and a safety integrity software 220 are running.

The operation of the software 220 is monitored by a watchdog 240. Moreover, the MCU includes one or more monitoring units 250, which continuously check the behaviour of MCU components for consistency, which is not illustrated. A central component of the inventive system is the SSU 200, which is illustrated in the middle of FIG. 2. As can be easily recognized, the SSU 200 receives information from the software 220, from at least one monitoring unit 250 and/or from the watchdog 240. The SSU 200 determines a reaction based on the received information (e.g. error code) to output instructions to the CPU 210 (e.g. reset), to the safety integrity software 220 (e.g. information on error states), to a monitor unit 250 (e.g. to enforce certain behavior of the monitor unit 250) or to the safety switch 230, which is arranged outside of the MCU.

The SSU 200 is interacting with individual components of the MCU 10. A first interaction occurs between the SSU 200 and the safety integrity software 220. This is caused by the need for a close interaction with the software safety integrity functions running on the CPU 210 as those can implement applications specific safety behavior more easily than the SSU 200. In addition SSU 200 can trigger error reactions like a reset or the safety switch 230 or ask the software for an appropriate reaction. However, there might be also an interaction with between the SSU 200 and the safety software, in case of receiving requests or commands from the safety integrity software.

Thus, the SSU 200 is gathering reports on errors or unexpected situations from the hardware components and will coordinate the reaction with the software safety function. Moreover, the SSU is executing measures to avoid critical situations that could be relevant for the safety of the system.

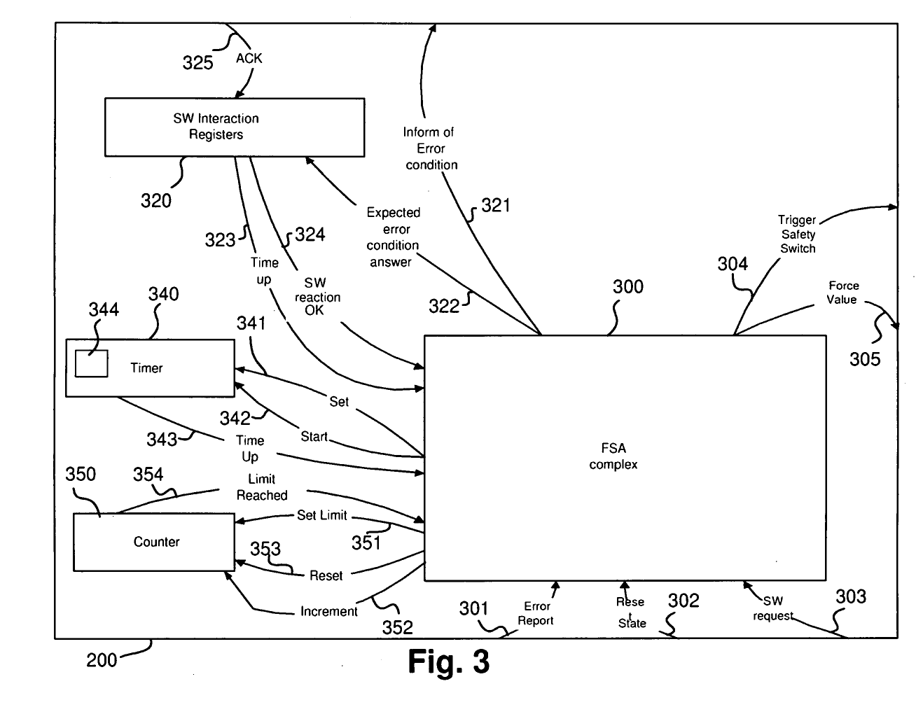

The internal construction of the SSU 200 is shown in FIG. 3. The SSU 200 includes a finite state automaton 300, which is receiving a plurality of information and which is outputting a plurality of information. Moreover, the SSU 200 includes at least one counter 350, at least one timer 340 and a software interaction register 320.

The arrangement of the counter 350, the timer 340 and the software interaction register 320 allow more complex reactions, like delayed responses, counting or interaction deadlines without enlarging the FSA itself. The software interaction register 320 receives an expected error condition answer 322 from the FSA 300. In parallel to this information, the software 220 is informed of this error condition 321. The software interaction register 320 receives an answer from the software 220, which is compared in the software register 320, wherein in case that the software reaction is not as expected the FSA 300 is informed. In general it may be assumed that the software reaction will be okay by default. Therefore, an event triggering any outputs of the FSA is needed only if the software reaction is not as expected or if the system safety time is too short for an interaction between SSU 200 and the software 220.

Additionally, to the information whether the software reaction on the reported error condition is not okay, the software interaction register 320 provides a “time is up” signal 323 to the FSA 300 in case no reaction occurred within a determined time.

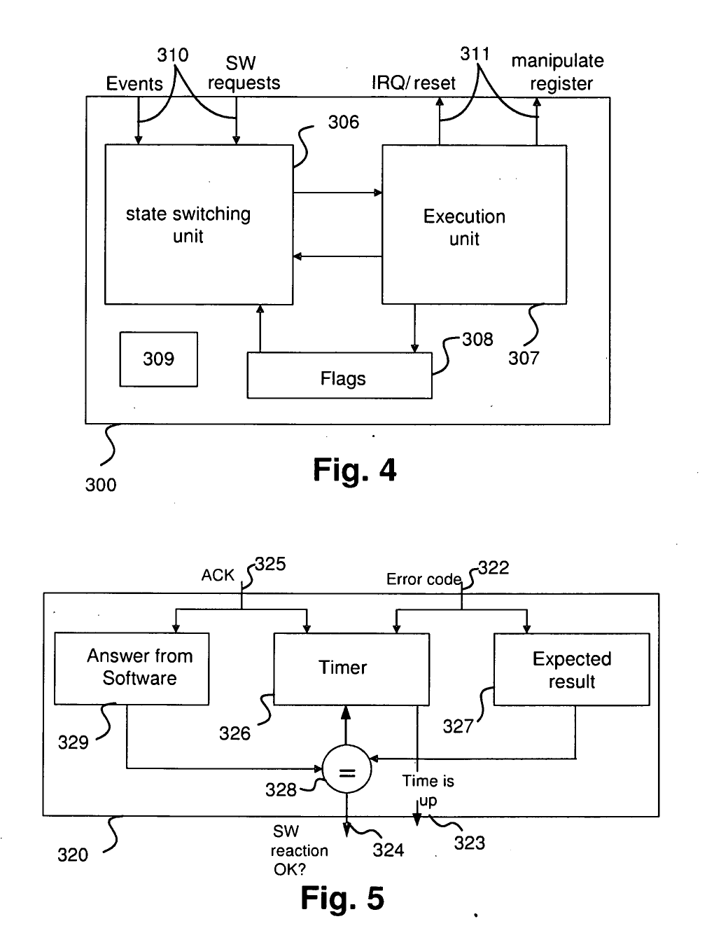

Before explaining the features of the components of the SSU, the internal construction of the FSA 300 will be explained, which is illustrated in more detail in FIG. 4. The FSA 300 includes an input port 310 for receiving software requests or events from components of the SSU or from components of the MCU. The input signals are provided to the state switching unit 306, which represents the FSA core. The FSA 300 may have a plurality of state switching units, however, due to the simplicity only one state switching unit 306 is shown. The state switching unit 306 is responsible to determine the transition from a former internal state to a current internal state. Thus, the state switching unit 306 provides the function: State×Event→Transition.

The state switching unit 306 is coupled to the execution unit 307, which is executing very simple actions (such as setting SSU internal registers) associated with a transition, wherein the new state is provided back to the state switching unit 306 after executing the predetermined actions. This allows to easily associate several consecutive actions to one transition or to a new state. This is necessary as the FSA 300 has to interact with several SSU components, MCU components as well as external components of the MCU, e.g. the safety switch. The realization with only one action per transition would require several unconditional transitions to replicate the same functionality. To keep the FSA simple and thus easy to realize reliably the execution unit 307 can only execute very basic commands, for example to set a signal line to a high or low logic level, to set a SSU internal register to a certain value or to set a bit in the SSU internal register. Any functions like comparisons are shifted to other components outside the FSA (e.g. to the software interaction register or a counter). A plurality of state switching units 306 may be used in case several safety-related functions are executed on the MCU, wherein each of which interacts with a different kind of FSA in the SSU. Moreover, the FSA 300 includes a flag register 308, which may be used for storing additional information to avoid increasing the number of state. The new internal state of the FSA 300 may be initiated by the execution unit 307. Alternatively, it could also be calculated directly in the state switching unit 306, if the execution unit 307 provides the confirmation when it has executed all action associated with a transition. The State×Event→Transition table of the FSA, as well as the action list to be executed by the execution unit 307 are stored in the storage unit 309. This storage unit 309 may be a ROM for a fixed reaction or may be flash or RAM memory which provides to keep the instruction valid for the whole lifetime of the FSA, or at least until the next software upgrade.

The execution unit 307 outputs instructions like interrupt requests (IRQ) or reset signals to the CPU 210 or to the safety switch 320. Moreover, it is possible to output instructions for manipulating a register 320.

The SSU 200 includes one or more timer 340, which provides the ability to wait for predetermined time, e.g. to delay a reset to allow possible software clean up or to wait if an error corrects itself. For this, the timer 340 may start one of the timers which is set or started by information 341, 342 outputted by the FSA 300. The timer 340 provides after reaching a predetermined time limit a “time is up” signal 343 to the FSA. Thus, the FSA 300 may be switched depending on the provided information to another state when a certain timer has been expired.

Moreover, the SSU 200 includes a counter 350, which may include a plurality of different counts. The counts are set and incremented/decremented by the FSA 300 via the signals 351, 352 or reset by signal 353. In case that a certain threshold has been reached, the counter 350 informs the FSA 300 via signal 344 that a certain counting limit has been reached. Thus, it is possible to apply a certain number of resets before giving up or to count remaining redundancy. By using counters 350 arranged external to the finite state automaton, a state explosion in the FSA 300 is avoided since the dedicated counters can be set, increased or reset by the FSA and will send a notification only once when the limit is reached.

Additionally, the FSA 300 may trigger the safety switch 320 or may reset the CPU 210 or the whole MCU 10. In case of predetermined errors, the FSA 300 may instruct a monitor unit 250 to force an output of the MCU to a specific value. Further, the FSA receives commands from the safety integrity software for a start-up diagnosis of the safety switch or to allow safety functions, which are realized in software, to trigger the safety switch 320 themselves. However, the safety functions ask the FSA to trigger the safety switch 320, wherein the FSA 300 will decide based on its internal state and the received information whether the safety switch 230 could be triggered or not. Thus, it is avoided to wrongly trigger the safety switch in case of erroneously operating safety integrity software.

Moreover, the FSA 300 is informed by the safety integrity software 220 about errors detected by the safety functions realized in software, which might reduce the remaining redundancy although the hardware still looks correct. As already mentioned above, the FSA 300 may be informed by the monitor unit 250 or other hardware components about detected errors to influence the reaction on the detected errors.

In following, the operation of the software interaction register 320 will be explained in more detail. The software interaction register 320 includes a register 329 for storing an answer of the software 220 and a register 327 for storing an expected result, which is written by the FSA 300 based on the detected error condition. Due to appropriate internal connections it is ensured that register 329 can only be written by the CPU (which means by the software) and that register 327 can only be written by SSU components. As shown in FIG. 3, in case of an error the FSA 300 informs the safety integrity software that a certain error has occurred. In parallel based on the error an expected error code answer is written into the register 327. When writing the expected error condition answer, a timer 326 is started.

As mentioned, the error condition has been transmitted also to the safety integrity software 220, which may solve the error alone or in conjunction with other software parts 220 and will then provide the corresponding information 325 to the software interaction register 320, which is stored in the register 329. The answer from the software is compared in the comparing unit 328. In case that the software reaction is okay, the software will have calculated and responded with a correct answer. This is reported to the FSA 300 via information 324. The same applies in case that the software reaction is not as expected causing an incorrect answer. In addition when the information from the software 220 is not received before the timer 326 has been expired, the software interaction register 320 provides a “time is up” signal 323 to the FSA to provide the possibility to react by the FSA 300 since the software 220 is not able to correct the error within time.

In case a second error occurs while the software has not yet reacted on a first one, which can be detected e.g. due to the timer 326 of the software interaction register 320 still running when the expected result 327 is to be written, the preferred reaction is for the FSA 300 to trigger the safety switch. Alternatively several software interaction registers 320 could be integrated or the situation could be solved by appropriate states and transitions in the FSA 300.

In the following, a table is provided giving an example of the state transitions and corresponding operations of an SSU which receives data from a redundant sensor via two I/O ports, preprocesses it and forwards it via the in-vehicle network.

Please note that this table is not complete and does not cover all operations possible. Also it is meant as an educational example and thus contains transitions and reactions not fit for use in a safety critical system.

| | | | Other | |
|---|---|---|---|---|
| Nr. | Event | In state | condition | Actions |
| 1 | CPU fault, Bus | All but Shutdown | — | Reset MCU |
| | fault, MCU | | | Disable information forwarding via |
| | auxiliaries fault | | | the IVN |
| | | | | Clear “Recoverable” Flag |
| | | | | New state: Shutdown |
| 2 | watchdog notice | All but Shutdown | — | Reset SW |
| | | | | Disable information forwarding via |
| | | | | the IVN |
| | | | | Set “Recoverable” Flag |
| | | | | New state: Shutdown |
| 3 | Input IO 0 fault | OK or memory | | Notify SW |
| | | fault | | Increase IO fault counter |
| | | | | Command Software interaction |
| | | | | register to expect SW respond A in a |
| | | | | preset time (sst) |
| | | | | New State: IO fault |
| 4 | Input IO 1 fault | OK or memory | | Notify SW |
| | | fault | | Increase IO fault counter |
| | | | | Command Software interaction |
| | | | | register to expect SW respond B in a |
| | | | | preset time (sst) |
| | | | | New State: IO fault |
| 5 | IO fault counter | IO fault or | | Notify SW (might want to send a final |
| | reaches its limit | memory fault | | message) |
| | (i.e. >1) | | | Start shutdown delay timer for a |
| | | | | preset time |
| | | | | (y) |
| | | | | New State: IO double fault |
| 6 | SW reports | All but Shutdown | — | Increase IO fault counter |
| | inconsistency | | | New State: same as before |
| | between sensors | | | |
| 7 | Memory fault | OK or IO fault or | — | Notify SW Expect SW response D in |
| | | IO Double Fault | | a preset time (sst) |
| | | | | New state: Memory fault |
| 8 | Network IO fault | All but Shutdown | — | Notify SW (Error code, IRQ?) |
| | | | | Disable information forwarding via |
| | | | | the IVN |
| | | | | Clear “Recoverable” Flag |
| | | | | New state: Shutdown |
| 9 | SW interaction | All but Shutdown | Expected | Reset SW |
| | Timer runs out | | SW | Disable information forwarding via |
| | | | response | the IVN |
| | | | not there | Set “Recoverable” Flag |
| | | | | New state: Shutdown |
| 10 | Wrong response | All but Shutdown | — | Reset SW |
| | by SW in SW | | | Disable information forwarding via |
| | interaction register | | | the IVN |
| | | | | Set “Recoverable” Flag |
| | | | | Stop SW interaction register timer |
| | | | | New state: Shutdown |
| 11 | Shutdown delay | IO Double fault | — | Reset MCU |
| | Timer runs out | | | Disable information forwarding via |
| | (the timer started | | | the IVN |
| | in row 5) | | | New state: Shutdown |
| 12 | Restart | Shutdown | “Recoverable” | Re-enable information forwarding via |
| | | | Flag | the IVN |
| | | | is set | New state: OK |

The table list the events (typically an error report) and the states in which this event will be handled by the SSU. The states relevant in this example are “OK”, “IO fault”, “IO Double Fault”, “Memory Fault”, and “Shutdown”. There is one counter in this example (“IO fault counter”) which is initialized to a limit of 2, a timer (“shutdown delay timer”) and a flag (“Recoverable”). Several monitoring units supervise the CPU, the bus, the memory, the input IO ports, the network IO port, and some auxiliary components of the MCU (e.g. clock generation). The actions of the SSU consist of resetting (parts of) the MCU, and setting registers internal to the SSU.

As can be seen in many situations the safety integrity software running on the CPU is given the chance to declare an error to be “under control” if the safety integrity software replies correctly to the SSU notification within the system safety time (sst), see e.g. row 3 which itself does not contain any safety-relevant action of the SSU. Sometimes also the SW is given time for clean up actions, e.g. to notify other MCUs on the network that the first MCU is about to shut down due to an error (see row 5). In other situations, when the correct execution of the safety integrity software is in question from the beginning (row 1) or due to lack of a consistent response (row 9 and 10) the SSU acts on its own to ensure the safe state of the system.

1. A system for providing fault tolerance for at least one micro controller unit (MCU), the MCU is adapted to receive information from at least one device coupled to the MCU and to output information to at least one further device coupled to the MCU, the MCU comprises:
a CPU; and
a System Supervision unit (SSU), for reacting on error reports included in information received at the SSU; wherein the SSU is adapted to switch into one of a plurality of predetermined states based on the information received and based on a state history of the MCU; and
to output at least one instruction to the MCU or to an external control device coupled to the MCU to control at least the MCU and/or the connected devices based on the new state into which the SSU is switched.

2. The system according to claim 1, wherein the SSU further includes a finite state automaton, (FSA), including:
an information input port adapted to receive the information from the MCU or from components of the SSU;
a state switching unit adapted to switch into one of a plurality of predetermined states based on the information received at the information input and based on the state history of the MCU;
an execution unit adapted to read a current internal state of the state switching unit and to execute at least one action associated with current internal state; and
an information output port adapted to output the at least one instruction to the MCU or to the external control device.

3. The system according to claim 1, wherein the execution unit is able to set a signal line in its logical level or to set an SSU internal register to a predetermined value.

4. The system according to claim 1, wherein the external control device is realized as a safety switch and is adapted to transfer the controlled system into a save state by transmitting a first predetermined instruction to the MCU and/or the connected devices.

5. The system according to claim 1, wherein the MCU further comprises software, which is running on the CPU, the software is receiving information from the SSU and is adapted to output information to the SSU.

6. The system according to claim 5, wherein the SSU comprises
a software interaction register adapted to compare an expected error code answer sent by the FSA with an error code answer (ACK) received from the software after the software was notified of an error by the SSU.

7. The system according to claim 6, wherein the software interaction register is adapted to receive an error code answer from the software indicating whether the error detected by the FSA could be solved by the software or not, such that in the case of solving the error by the software the error code answer corresponds to the expected error code answer and in the case not solving the error by the software no corresponding answer is sent by the software, and the respective result is transmitted to the SSU.

8. The system according to claim 1, further including at least one monitoring unit adapted to detect errors in various parts of the MCU and to report these errors to the SSU, wherein the monitoring unit is outputting an error report to the SSU indicating a predetermined error.

9. The system according to claim 1, wherein the SSU further includes a counter adapted to start at least one count, to increment or decrement the at least one count and/or to reset the at least one count based on the internal states of the FSA.

10. The system according to claim 1, further comprising a timer adapted to start and to stop at least one timer based on the internal states of the FSA and to output a time-up signal, if a predetermined time interval is expired.
